(19) United States
(12) Patent Application Publication
(10) Pub. No.: US 2024/0045186 A1
(43) Pub. Date: Feb. 8, 2024

(54) ZOOM LENS AND IMAGE PICKUP APPARATUS HAVING THE SAME

(71) Applicant: CANON KABUSHIKI KAISHA, Tokyo (JP)

(72) Inventor: Takashi OKADA, Saitama (JP)

(21) Appl. No.: 18/339,262

(22) Filed: Jun. 22, 2023

(30) Foreign Application Priority Data
Jul. 29, 2022 (JP) 2022-122144

(51) Int. Cl. G02B 15/177; G02B 15/14

(52) U.S. Cl. CPC G02B 15/177; G02B 15/145523; G02B 15/144511

(57) ABSTRACT

A zoom lens includes, in order from the object side to the image side, a first lens unit having negative refractive power, a second lens unit having positive refractive power. A distance between adjacent lens units changes during zooming from a wide-angle end to a telephoto end. During zooming from the wide-angle end to the telephoto end, the first lens unit moves to the image side and then to the object side. The first lens unit includes four lenses or more, the four lenses or more including, in order from the object side to the image side, a first negative meniscus lens with a convex surface facing the object side and a second negative meniscus lens with a convex surface facing the object side. A predetermined condition is satisfied.

### BACKGROUND

### Technical Field

One of the aspects of the embodiments relates generally to a zoom lens, and more particularly to a zoom lens suitable for a digital video camera, a digital still camera, a broadcasting camera, a film-based camera, a surveillance camera, and the like.

### Description of Related Art

Recently, an image pickup apparatus such as a digital still camera using a solid-state image sensor has often been used not only for still image capturing but also for moving (or motion) image capturing. The moving image is often captured in scenes in which a person is captured in a wide background and thus requires a wide-angle lens.

A wide-angle zoom lens generally has a so-called negative lead type, in which a lens unit having negative refractive power is located closest to the object. In particular, in a wide-angle zoom lens having an angle of view less than 16 mm at a wide-angle end in the 35 mm conversion, the lens unit having negative refractive power includes a plurality of negative meniscus lenses convex to the object side. This is to correct barrel distortion and field curvature caused by strong negative refractive power.

Japanese Patent Laid-Open No. 2021-179531 discloses a zoom lens that includes, in order from the object side, having first, second, third, and fourth lens units having negative, positive, negative, and positive refractive powers, respectively.

However, in a zoom lens that includes a negative meniscus lens that is convex toward the object side and disposed closest to the object, light reflected from lenses on the image side of the negative meniscus lens is returned to the image side by the negative meniscus lens and is likely to cause a ghost. In particular, as the curvature of the meniscus lens increases, an antireflection effect weakens at the peripheral portion of the lens, and the ghost remarkably appears.

The zoom lens disclosed in Japanese Patent Laid-Open No. 2021-179531 has a problem that the light reflected by the peripheral portion of the meniscus lens closest to the object reaches the imaging range of the image sensor and may cause a ghost.

### SUMMARY

A zoom lens according to one aspect of the disclosure includes, in order from an object side to an image side, a first lens unit having negative refractive power, a second lens unit having positive refractive power. A distance between adjacent lens units changes during zooming from a wide-angle end to a telephoto end. During zooming from the wide-angle end to the telephoto end, the first lens unit moves to the image side and then to the object side. The first lens unit includes four lenses or more, the four lenses or more including, in order from the object side to the image side, a first negative meniscus lens with a convex surface facing the object side and a second negative meniscus lens with a convex surface facing the object side. The following inequalities are satisfied:

0.9<G1R2/D1<2.0

−9.0<fa/fw<−2.0

1.8<N1<2.1

where G1R2 is a radius of curvature of a lens surface on the image side of the first negative meniscus lens, D1 is a distance on an optical axis from a lens surface closest to an object to a lens surface closest to an image plane of the first lens unit, fa is a focal length of an air lens between the first negative meniscus lens and the second negative meniscus lens, fw is a focal length of the zoom lens at the wide-angle end, and N1 is a refractive index of the first negative meniscus lens. An image pickup apparatus having the above zoom lens also constitutes another aspect of the disclosure.

Further features of the disclosure will become apparent from the following description of embodiments with reference to the attached drawings.

### BRIEF DESCRIPTION OF THE DRAWINGS

FIG. 1 is a lens sectional view at a wide-angle end of a zoom lens according to Example 1 in an in-focus state at infinity.

FIG. 2A is an aberration diagram at the wide-angle end of the zoom lens according to Example 1 in the in-focus state at infinity. FIG. 2B is an aberration diagram at an intermediate (middle) zoom position of the zoom lens according to Example 1 in the in-focus state at infinity. FIG. 2C is an aberration diagram at a telephoto end of the zoom lens according to Example 1 in the in-focus state at infinity.

FIG. 3 is a lens sectional view at a wide-angle end of a zoom lens according to Example 2 in an in-focus state at infinity.

FIG. 4A is an aberration diagram at the wide-angle end of the zoom lens according to Example 2 in the in-focus state at infinity. FIG. 4B is an aberration diagram at an intermediate (middle) zoom position of the zoom lens according to Example 2 in the in-focus state at infinity. FIG. 4C is an aberration diagram at a telephoto end of the zoom lens according to Example 2 in the in-focus state at infinity.

FIG. 5 is a lens sectional view at a wide-angle end of a zoom lens according to Example 3 in an in-focus state at infinity.

FIG. 6A is an aberration diagram at the wide-angle end of the zoom lens according to Example 3 in the in-focus state at infinity. FIG. 6B is an aberration diagram at an intermediate (middle) zoom position of the zoom lens according to Example 3 in the in-focus state at infinity. FIG. 6C is an aberration diagram at a telephoto end of the zoom lens according to Example 3 in the in-focus state at infinity.

FIG. 7 is a lens sectional view at a wide-angle end of a zoom lens according to Example 4 in an in-focus state at infinity.

FIG. 8A is an aberration diagram at the wide-angle end of the zoom lens according to Example 4 in the in-focus state at infinity. FIG. 8B is an aberration diagram at an intermediate (middle) zoom position of the zoom lens according to Example 4 in the in-focus state at infinity. FIG. 8C is an aberration diagram at a telephoto end of the zoom lens according to Example 4 in the in-focus state at infinity.

FIG. 9 is a schematic diagram of an image pickup apparatus.

### DESCRIPTION OF THE EMBODIMENTS

Referring now to the accompanying drawings, a description will be given of a zoom lens according to an embodiment of the present disclosure and an image pickup apparatus having the zoom lens.

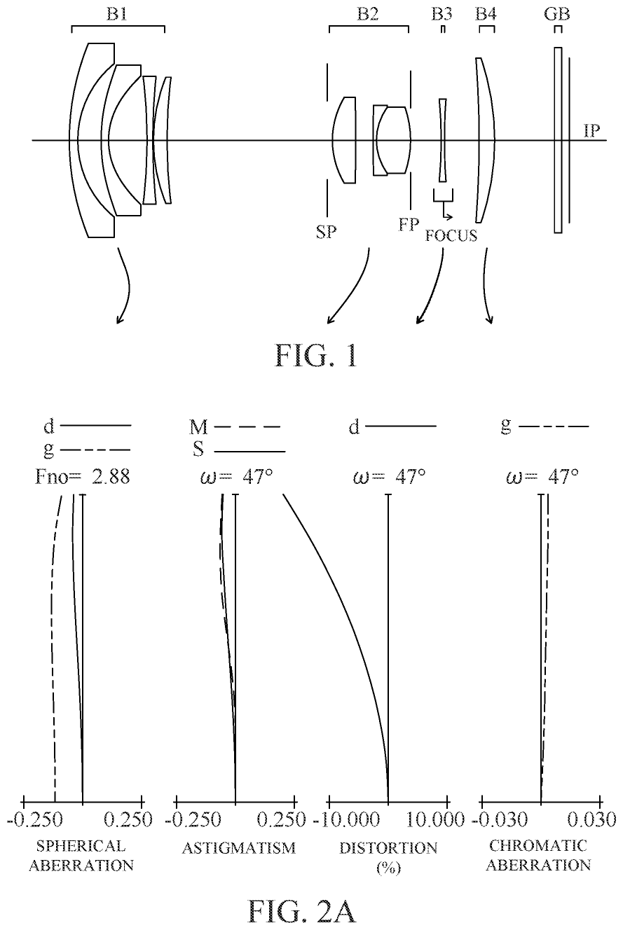

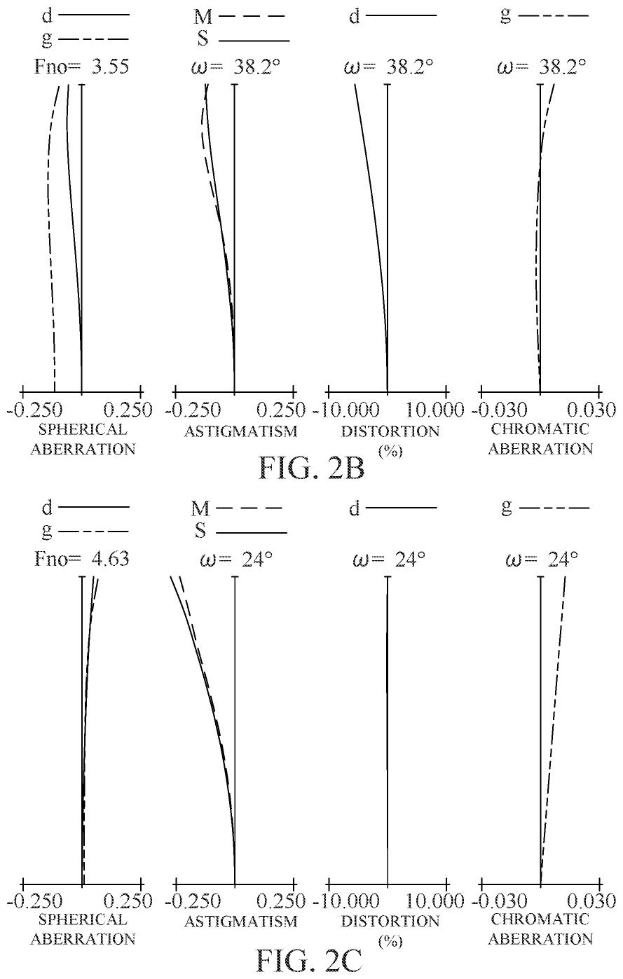

FIG. 1 is a lens sectional view at a wide-angle end of a zoom lens according to Example 1 in an in-focus state at infinity. FIGS. 2A, 2B, and 2C are aberration diagrams at the wide-angle end, an intermediate (middle) zoom position, and a telephoto end of the zoom lens according to Example 1 in the in-focus state at infinity.

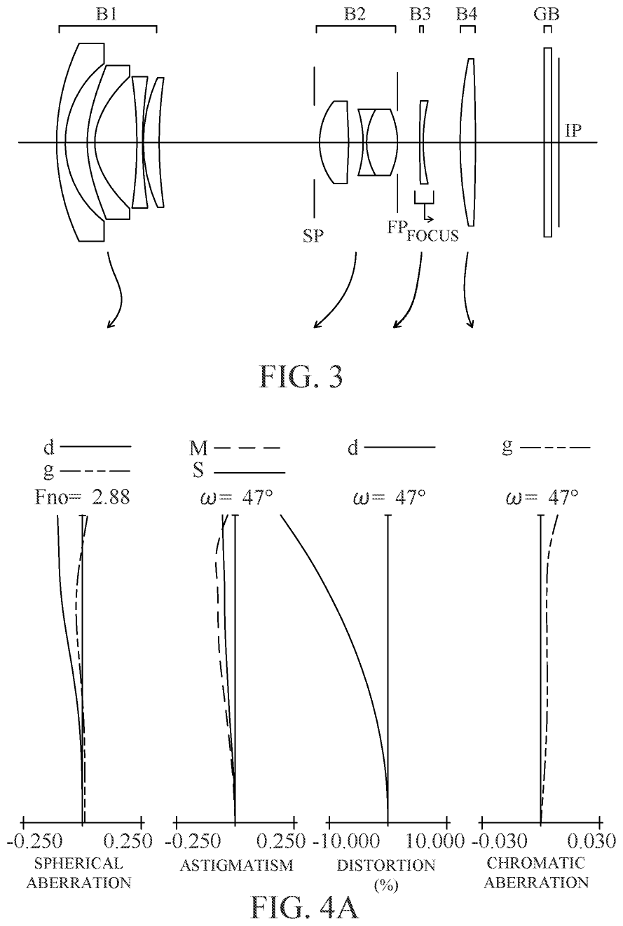

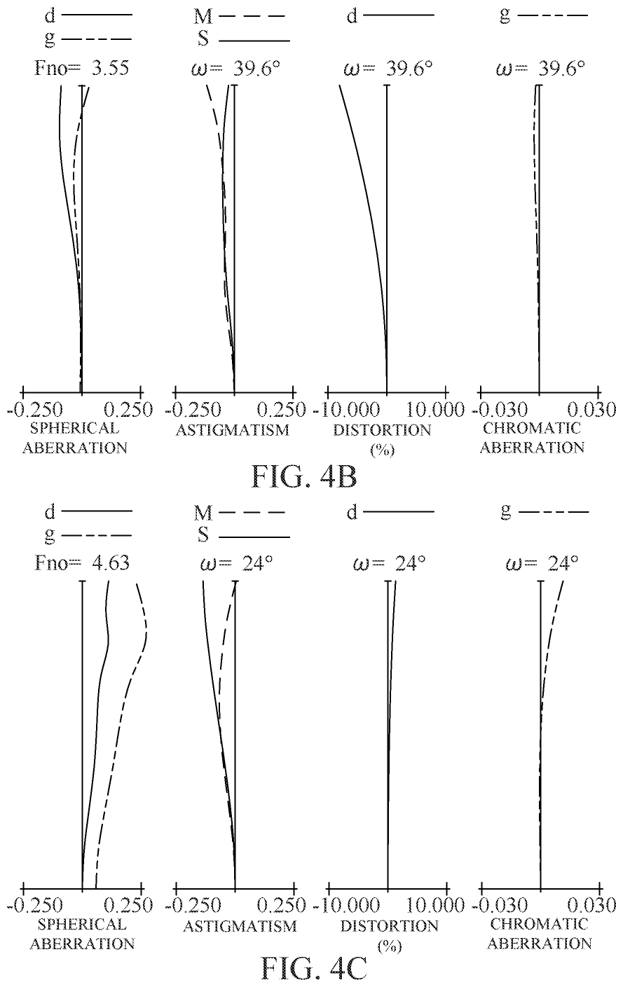

FIG. 3 is a lens sectional view at a wide-angle end of a zoom lens according to Example 2 in an in-focus state at infinity. FIGS. 4A, 4B, and 4C are aberration diagrams at the wide-angle end, an intermediate (middle) zoom position, and a telephoto end of the zoom lens according to Example 2 in the in-focus state at infinity.

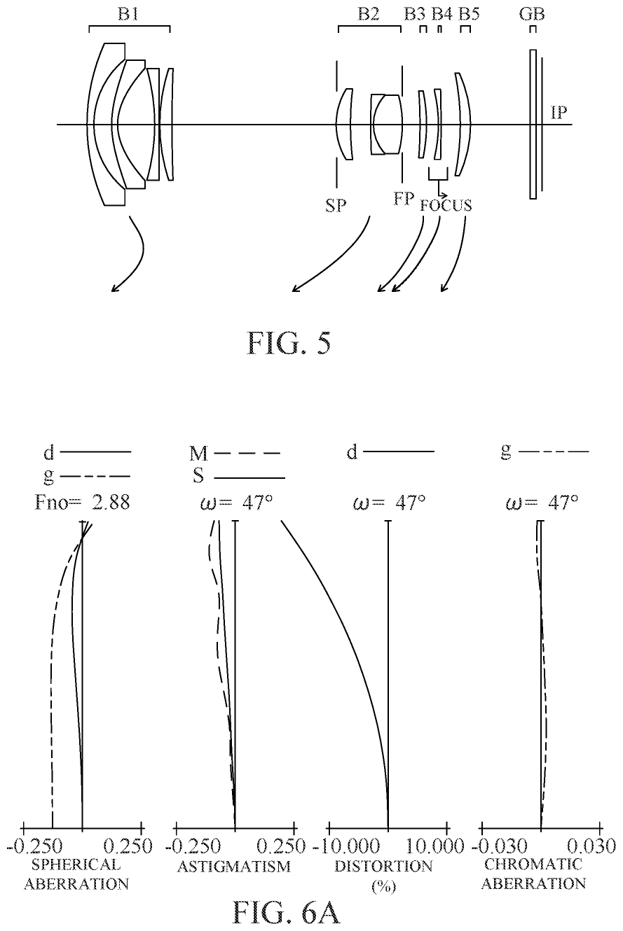

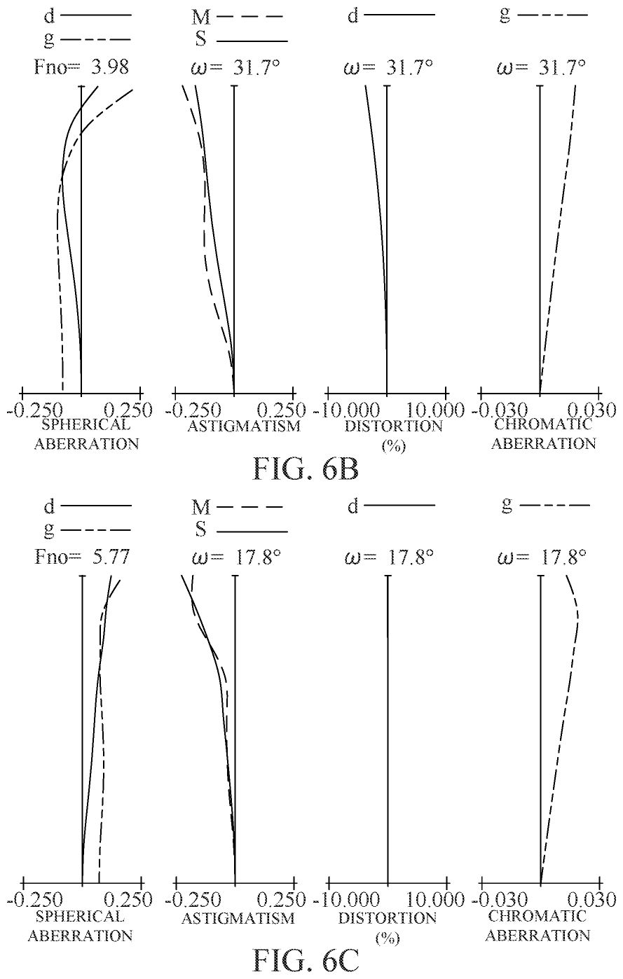

FIG. 5 is a lens sectional view at a wide-angle end of a zoom lens according to Example 3 in an in-focus state at infinity. FIGS. 6A, 6B, and 6C are aberration diagrams at the wide-angle end, an intermediate (middle) zoom position, and a telephoto end of the zoom lens according to Example 3 in the in-focus state at infinity.

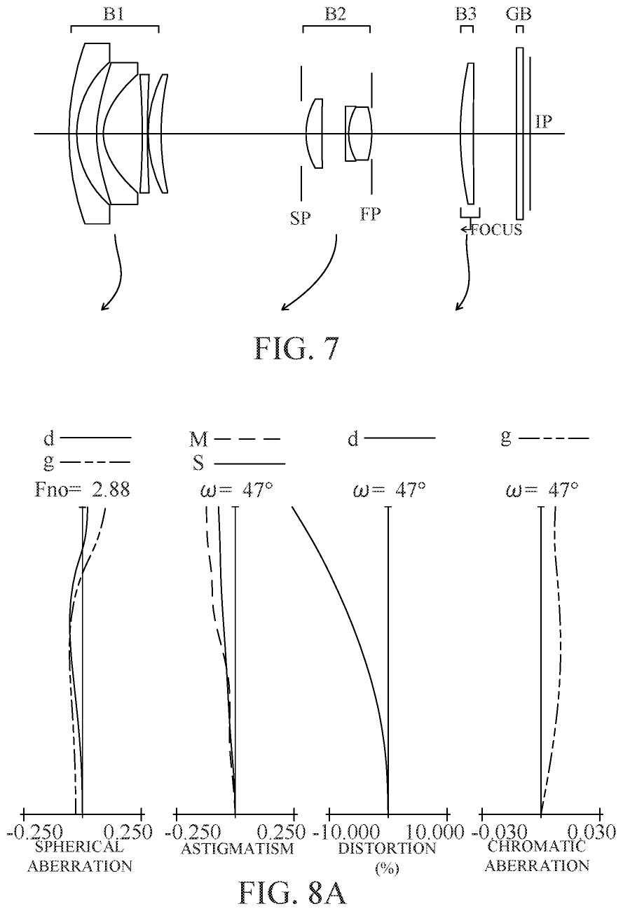

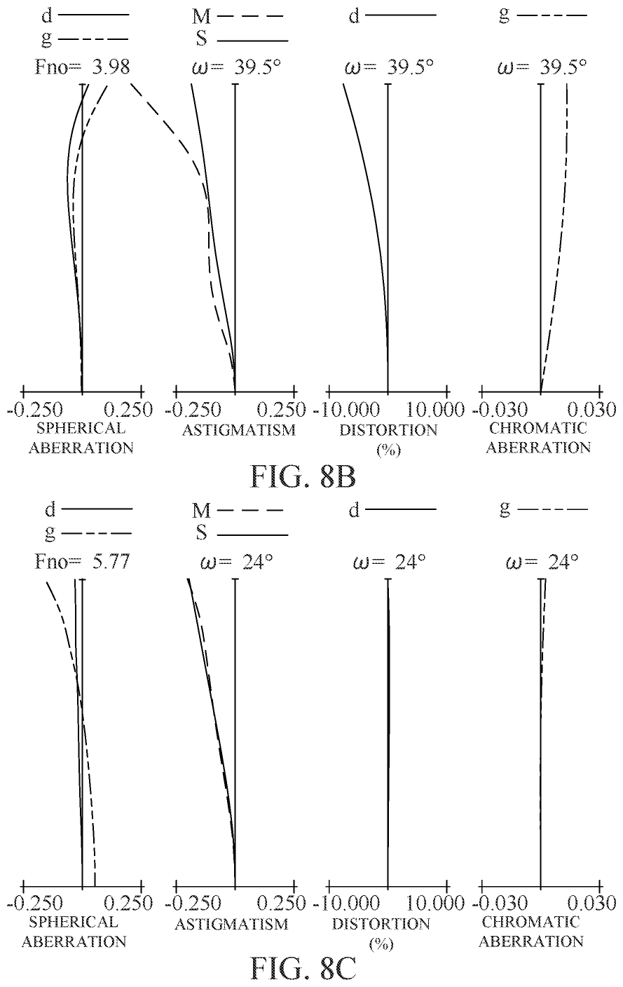

FIG. 7 is a lens sectional view at a wide-angle end of a zoom lens according to Example 4 in an in-focus state at infinity. FIGS. 8A, 8B, and 8C are aberration diagrams at the wide-angle end, an intermediate (middle) zoom position, and a telephoto end of the zoom lens according to Example 4 in the in-focus state at infinity.

The zoom lens according to each example is an optical system that is used for an image pickup apparatus such as a digital video camera, a digital still camera, a broadcasting camera, a film-based camera, and a surveillance camera.

In each lens sectional view, a left side is an object side, and a right side is an image side. The zoom lens according to each example includes a plurality of lens units. In this specification, a lens unit is a group of lenses that move or stand still during zooming. In other words, regarding a zoom lens that drives a part of lenses in a lens unit during focusing or image stabilization, a plurality of lenses that similarly move during zooming are regarded as a single lens unit. In the zoom lens according to each example, a distance between adjacent lens units changes during zooming from the wide-angle end to the telephoto end. The lens unit may include one or more lenses. The lens unit may include an aperture stop.

In each lens sectional view, i (which is natural number) represents the order of lens units counted from the object side, and Bi is an i-th lens unit. For example, B1 is a first lens unit and B2 is a second lens unit.

SP represents an aperture stop, and the aperture stop SP is disposed on the object side of the second lens unit B2. Disposing the aperture stop SP on the object side of the second lens unit B2 reduces a distance from the first lens unit B1, which is beneficial to reduction of the diameter of the front lens. In addition, since flare at the intermediate image height at the wide-angle end can be cut, it is beneficial to high performance. Moving the aperture stop SP distant from the solid-state image sensor can reduce the incident angle on the solid-state image sensor, which is beneficial to high image quality by suppressing deterioration of an image caused by shading and the like. The aperture stop SP can be disposed on the image side of the second lens unit B2. In a case where the aperture stop SP is disposed on the image side of the second lens unit B2, it becomes unnecessary to dispose an aperture mechanism between the first lens unit B1 and the second lens unit B2 and a distance between the first lens unit B1 and the second lens unit B2 at the telephoto end can be reduced. Thereby, a magnification variation ratio of the zoom lens can be easily secured. In each example, the aperture stop SP moves integrally with the second lens unit B2. This configuration eliminates the need for a cam groove for the aperture stop SP, increasing the degree of freedom in mechanical design. On the other hand, the second lens unit B2 and the aperture stop SP may be moved separately. In a case where the aperture stop SP is moved separately, flare at a low image height can be cut at an intermediate zoom position, and a high image quality zoom lens can be realized.

FP represents a flare cut diaphragm that cuts unnecessary light. GB represents an optical block corresponding to an optical filter, a face plate, a crystal low-pass filter, an infrared cut filter, and the like. IP represents an image plane. In a case where the zoom lens according to each example is used as an imaging optical system of a digital still camera or a digital video camera, the imaging plane of a solid-state image sensor (photoelectric conversion element) such as a CCD sensor or a CMOS sensor is placed on the image plane IP. In a case where the zoom lens according to each example is used as an imaging optical system of a film-based camera, a photosensitive plane corresponding to a film plane is placed on the image plane IP.

In each lens sectional view, an arrow indicates a moving locus of a lens unit that moves during zooming from the wide-angle end to the telephoto end. An arrow relating to FOCUS indicates a moving direction of a lens unit that moves during focusing from infinity to close (a short distance).

In a spherical aberration diagram, Fno represents an F-number. The spherical aberration diagram indicates spherical aberration amounts for the d-line (wavelength 587.6 nm) and g-line (wavelength 435.8 nm). In an astigmatism diagram, dS indicates an astigmatism amount on a sagittal image plane, and dM indicates an astigmatism amount on a meridional image plane. A distortion diagram illustrates a distortion amount for the d-line. A chromatic aberration diagram illustrates a chromatic aberration amount for the g-line. ω is a paraxial imaging half angle of view (°).

In each of the following examples, the wide-angle end and the telephoto end correspond to zoom positions in a case where the lens unit for magnification variation is mechanically located at both ends of a movable range on the optical axis in a normal imaging area.

A description will now be given of a characteristic configuration of the zoom lens according to each example.

The zoom lens according to each example includes, in order from the object side to the image side, a first lens unit B1 having negative refractive power and a second lens unit B2 having positive refractive power. In this zoom lens, a distance between adjacent lens units changes during zooming from the wide-angle end to the telephoto end. During zooming from the wide-angle end to the telephoto end, the first lens unit B1 and the second lens unit B2 move so as to reduce the distance between them. The first lens unit B1 moves to the image side, and then moves to the object side. That is, during zooming from the wide-angle end to the telephoto end, the first lens unit B1 moves with a locus (trajectory) convex toward the image side. Here, the locus of the lens unit A convex to the image side means that a moving amount of the lens unit A from the wide-angle end in the in-focus state at infinity has a maximum value in the intermediate area during zooming where the lens unit A has a positive value in moving to the image side. Moving the second lens unit B2 toward the object side can secure a magnification variation ratio and realize high magnification, but in order to maintain the imaging position by the second lens unit B2, the first lens unit B1 moves with a locus convex toward the image side.

The first lens unit B1 includes four lenses or more. The four lenses or more include, in order from the object side to the image side, a first negative meniscus lens with a convex surface facing the object side and a second negative meniscus lens with a convex surface facing the object side.

A wide-angle zoom lens with a focal length of less than 20 mm at the wide-angle end generally uses a negative lead type zoom lens in which a lens unit having negative refractive power is disposed closest to the object. The shorter the focal length at the wide-angle end is, the shorter the focal length of the first lens unit B1 is, and the more significantly the distortion and curvature of field occur. In order to correct these aberrations, the first lens unit B1 includes a negative lens having a meniscus shape convex to the object side. In particular, in a case where the focal length at the wide-angle end is less than 16 mm, the aberrations cannot be corrected with a single negative meniscus lens. Thus, in each example, the first lens unit B1 includes two or more negative meniscus lenses having a convex surface facing the object side.

On the other hand, in a zoom lens in which the first lens unit Bi that is located closest to the object and includes a plurality of negative meniscus lenses, each of these meniscus lenses is required to have a high refractive index. Therefore, correction of chromatic aberration becomes difficult. Disposing a negative lens and a positive lens on the image side of these meniscus lenses enables various aberrations at the wide-angle end to be satisfactorily corrected.

As described above, in the ultra-wide-angle zoom lens according to each example, the first lens unit B1 includes four lenses and more. The four lenses or more include, in order from the object side to the image side, a first negative meniscus lens having a convex surface facing the object side, and a second negative meniscus lens having a convex surface facing the object.

In each example, the first lens unit B1 may include an aspherical lens. At least one lens surface of the second negative meniscus lens may be aspherical. The second negative meniscus lens may be an aspherical lens. Disposing the aspherical lens at a position where a chief paraxial ray is relatively high can improve the degree of freedom in correction of distortion and curvature of field, and realize a higher performance zoom lens. In order to provide the aspherical effect more effectively, the first negative meniscus lens through which the chief paraxial ray passes through a higher position may be an aspherical lens, but the cost may increase.

As described above, in a zoom lens in which the first lens unit disposed closest to the object includes a plurality of negative meniscus lenses, a light ray reflected between these meniscus lenses is converged toward the aperture stop SP. Therefore, in a case where a high intensity light source is disposed at the center of the wide-angle end, a strong ring-shaped ghost occurs around the light source. This example secures a proper configuration to avoid the ring-shaped ghost.

The first method for preventing the ring-shaped ghost is to soften the radius of curvature on the image side of the first negative meniscus lens in order to weaken the ghost intensity. As the radius of curvature on the image side of the first negative meniscus lens decreases, an opening angle at the peripheral portion of the lens increases. Thereby, the film thickness of the antireflection film becomes thin at the peripheral portion of the lens, and the reflectance at the peripheral portion of the lens becomes high.

The second effective method for preventing the ring-shaped ghost is to strengthen the refractive power of an air lens between the first negative meniscus lens and the second negative meniscus lens. Increasing this refractive power enables the ring-shaped ghost ray to reach the outside of the image sensor, and can suppress the ghost. In using an aspherical surface for the second negative meniscus lens, in order to effectively exhibit the aspherical effect, the distance between the first negative meniscus lens and the second negative meniscus lens may be reduced so that the chief paraxial ray passes through a position that is as high as possible. However, the reduced distance weakens the refractive power of the air lens and causes the ghost. It is thus important to adjust the balance between performance and ghost prevention.

Accordingly, the zoom lens according to each example includes, in order from the object side to the image side, a first lens unit B1 having negative refractive power and a second lens unit B2 having positive refractive power, and satisfies the following inequalities (1) to (3):

0.9<G1R2/D1<2.0 (1)

−9.0<fa/fw<−2.0 (2)

1.8<N1<2.1 (3)

Here, G1R2 is a radius of curvature of a lens surface on the image side of the first negative meniscus lens. In a case where the lens surface on the image side of the first negative meniscus lens is an aspherical surface, the reference curvature radius of the aspherical surface is the radius of curvature G1R2. D1 is a distance on the optical axis from a lens surface closest to the object to a lens surface closest to the image plane in the first lens unit B1. fa is a focal length of the air lens between the first negative meniscus lens and the second negative meniscus lens. The focal length fa of the air lens is, in a case where any of its surfaces is aspheric, calculated by the reference radius of curvature of that aspheric surface. fw is a focal length at the wide-angle end of the zoom lens in the in-focus state at infinity. N1 is a refractive index of the first negative meniscus lens.

Inequality (1) is an inequality for loosely setting the radius of curvature G1R2 on the image side of the first negative meniscus lens. In a case where the value of the radius of curvature G1R2 decreases and the value G1R2/D1 becomes lower than the lower limit of inequality (1), the curvature on the image side of the first negative meniscus lens becomes sharp and the opening angle of the peripheral portion of the lens increases. Thereby, the film thickness of the antireflection film becomes thin in the peripheral portion of the lens, and the reflectance in the peripheral portion of the lens increases. Hence, the ghost intensity passing through this portion is increased. In a case where the value of the radius of curvature G1R2 increases and the value G1R2/D1 becomes higher than the upper limit of inequality (1), the curvature on the image side of the first negative meniscus lens becomes loose, it becomes difficult to correct distortion at the wide-angle end, and performance deteriorates.

Inequality (2) is an inequality that defines the refractive power of the air lens between the first lens unit B1 and the second lens unit B2. In a case where the value of the focal length fa becomes small and the value fa/fw becomes lower than the lower limit of inequality (2), the refractive power of the air lens becomes too weak, and a ring-shaped ghost reaches the imaging area. In a case where the value of the focal length fa increases and the value fa/fw becomes higher than the upper limit of inequality (2), the lens diameter of the second negative meniscus lens decreases, the burden of the first negative meniscus lens for correcting distortion and field curvature increases, and it becomes difficult to correct aberrations.

Inequality (3) is an inequality that defines the refractive index of the first negative meniscus lens. In a case where the value of the refractive index N1 becomes lower than the lower limit of inequality (3), the refractive index of the first negative meniscus lens decreases, the curvature on the lens surface on the image side of the first negative meniscus lens becomes sharp, and the ghost intensity becomes stronger. In a case where the value of the refractive index N1 becomes higher than the upper limit of inequality (3), only materials with small dispersion can be selected for the first negative meniscus lens, and it becomes difficult to correct lateral chromatic aberration at the wide-angle end.

In order to realize a wide-angle and high-magnification zoom lens, inequalities (1) to (3) may be replaced with inequalities (1a) to (3a) below:

0.93<G1R2/D1<1.50 (1a)

−7.0<fa/fw<−3.0 (2a)

1.80<N1<1.96 (3a)

Inequalities (1) to (3) may be replaced with inequalities (1b) to (3b) below:

0.95<G1R2/D1<1.10 (1b)

−5.5<fa/fw<−4.0 (2b)

1.80<N1<1.92 (3b)

A description will now be given of conditions that the zoom lens according to each example may satisfy. The zoom lens according to each example may satisfy one or more of the following inequalities (4) to (9):

2.0<(G1R2+G2R1)/(G1R2−G2R1)<6.0 (4)

1.2<D1/fw<2.0 (5)

0.3<dg12/fw<0.6 (6)

0.1<fgho/Lw<1.5 (7)

−2.5<f1/fw<−1.5 (8)

−1.5<f1/f2<−0.5 (9)

Here, G2R1 is a radius of curvature of a lens surface on the object side of the second negative meniscus lens. In a case where the lens surface on the object side of the second negative meniscus lens is aspheric, the reference radius of curvature of the aspherical surface is the radius of curvature G2R1. dg12 is a distance on the optical axis from the lens surface on the image side of the first negative meniscus lens to the lens surface on the object side of the second negative meniscus lens (distance between the first negative meniscus lens and the second negative meniscus lens). fgho is a focal length of the first lens unit that reflects light twice by the meniscus lenses in a case where a light ray incident on the first lens unit is reflected by a lens surface on the object side of the second negative meniscus lens, is reflected on a lens surface on the image side of the first lens unit, and exits the first lens unit. That is, fgho is a focal length of the first lens unit B1 in a case where a light ray incident on the first lens unit is reflected by a lens surface on the object side of the second negative meniscus lens, is reflected on a lens surface on the image side of the first lens unit, and exits the first lens unit. Lw is an overall optical length of the zoom lens at the wide-angle end, and is a value of the zoom lens that does not include filters or flat plates in the in-focus state at infinity. That is, the overall optical length is a distance on the optical axis from the lens surface closest to the object to the image plane IP. f1 is a focal length of the first lens unit and f2 is a focal length of the second lens unit.

Inequality (4) is an inequality that defines a shape factor of the air lens between the first negative meniscus lens and the second negative meniscus lens. In a case where the value of the shape factor becomes smaller than the lower limit of inequality (4), the refractive power of the air lens becomes too strong, and aberration correction becomes difficult as described above. In a case where the value of the shape factor becomes higher than the upper limit of inequality (4), the air lens becomes crescent-shaped, and the refractive power of the air lens becomes weak. Thereby, a ring-shaped ghost reaches the imaging area.

Inequality (5) is the thickness D1 of the first lens unit B1 normalized by the focal length fw at the wide-angle end. In a case where the value of the thickness D1 becomes smaller and the value D1/fw becomes lower than the lower limit of inequality (5), the thickness D1 of the first lens unit B1 becomes too thin. Thereby, it becomes difficult to arrange lenses for correcting distortion and curvature of field. In a case where the value of the thickness D1 becomes larger and the value D1/fw becomes higher than the upper limit of inequality (5), the thickness D1 of the first lens unit B1 becomes too thick. Thereby, the thickness of the camera in the retracted state is increased, and the size of the camera increases.

Inequality (6) is an inequality that defines a ratio of the distance dg12 between the first negative meniscus lens and the second negative meniscus lens to the focal length fw. In a case where the value of distance dg12 decreases and the value dg12/fw becomes lower than the lower limit of inequality (6), the distance dg12 becomes narrower, the refractive power of the air lens weakens, and a ring-shaped ghost reaches the imaging area. In a case where the value of distance dg12 increases and the value dg12/fw becomes higher than the upper limit of inequality (6), the refractive power of the air lens increases, and it becomes difficult to correct aberrations. Alternatively, the diameter of the first negative meniscus lens becomes too large, and the size of the zoom lens increases.

Inequality (7) is an inequality that defines a focal length of a ghost system reflected by the first lens unit B1. In a case where the value of fgho/Lw becomes smaller than the lower limit of inequality (7), the refractive power of the air lens between the first negative meniscus lens and the second negative meniscus lens becomes strong, and aberration correction becomes difficult. In a case where the value of fgho/Lw is higher than the upper limit of inequality (7), the refractive power of the air lens between the first negative meniscus lens and the second negative meniscus lens weakens, and the ring-shaped ghost reaches the imaging area.

Inequality (8) is the focal length f1 of the first lens unit Bi normalized by the focal length fw at the wide-angle end. In a case where the value of the focal length f1 becomes smaller and the value f1/fw becomes lower than the lower limit of inequality (8), the refractive power of the first lens unit B1 becomes too weak, and it becomes difficult to reduce the focal length fw at the wide-angle end. In a case where the value of the focal length f1 becomes higher than the upper limit of inequality (8), the refractive power of the first lens unit B1 becomes too strong, and it becomes difficult to correct distortion and curvature of field.

Inequality (9) is an inequality that defines a ratio of the focal length f1 of the first lens unit B1 to the focal length f2 of the second lens unit. In a case where the value of f1/f2 becomes smaller than the lower limit of inequality (9), the focal length f1 of the first lens unit B1 becomes too weak relative to the focal length f2 of the second lens unit B2. Thus, it becomes difficult to reduce the focal length fw at the wide-angle end, or the overall lens length at the wide-angle end becomes long, the diameter of the front lens becomes large, and the size of the zoom lens increases. In a case where the value of f1/f2 becomes higher than the upper limit of inequality (9), the focal length f1 of the first lens unit B1 becomes too strong relative to the focal length f2 of the second lens unit B2. Therefore, it becomes difficult to correct distortion and curvature of field.

Inequalities (4) to (9) may be replaced with inequalities (4a) to (9a) below:

3.0<(G1R2+G2R1)/(G1R2−G2R1)<4.5 (4a)

1.5<D1/fw<1.7 (5a)

0.33<dg12/fw<0.4 (6a)

0.2<fgho/Lw<1.3 (7a)

−1.9<f1/fw<−1.6 (8a)

−1.0<f1/f2<−0.7 (9a)

Inequalities (4) to (9) may be replaced with inequalities (4b) to (9b) below:

3.1<(G1R2+G2R1)/(G1R2−G2R1)<4.3 (4b)

1.52<D1/fw<1.68 (5b)

0.34<dg12/fw<0.38 (6b)

0.22<fgho/Lw<1.28 (7b)

−1.89<f1/fw<−1.65 (8b)

−0.98<f1/f2<−0.75 (9b)

A detailed description will now be given of the zoom lens according to each example.

In Examples 1 and 2, the zoom lens includes, in order from the object side to the image side, a first lens unit B1, a second lens unit B2, a third lens unit B3 having negative refractive power, and a fourth lens unit B4 having positive refractive power. Each of the zoom lenses according to Examples 1 and 2 consists of the lens units B1 to B4 and an optical block GB disposed closest to the image plane. The aperture stop SP is disposed closest to the object in the second lens unit B2. The flare cut diaphragm FP is disposed closest to the image plane of the second lens unit B2. During zooming from the wide-angle end to the telephoto end, the third lens unit B3 moves to the object side and the fourth lens unit B4 moves to the image side so that the distance between the second lens unit B2 and the third lens unit B3 increases and the distance between the third lens unit B3 and the fourth lens unit B4 increases. Examples 1 and 2 adopt such a lens unit configuration and can satisfactorily correct upward flare while securing the burden of the magnification variation and achieving high performance.

In Example 3, the zoom lens includes, in order from the object side to the image side, a first lens unit B1, a second lens unit B2, a third lens unit B3 having positive refractive power, a fourth lens unit B4 having negative refractive power, and a fifth lens unit B5 having positive refractive power. The zoom lens according to Example 3 consists of these lens units B1 to B5 and an optical block GB located closest to the image plane. The aperture stop SP is disposed closest to the object in the second lens unit B2. The flare cut diaphragm FP is disposed closest to the image plane of the second lens unit B2. During zooming from the wide-angle end to the telephoto end, each of the lens units B3 to B5 moves toward the object side so that the distance between the second lens unit B2 and the third lens unit B3 increases, the distance between the third lens unit B3 and the fourth lens unit B4 narrows, and the distance between the fourth lens unit B4 and the fifth lens unit B5 increases. Example 3 adopts such a lens unit configuration, can increase a magnification variation ratio, effectively correct coma and curvature of field over the entire zoom range by using a plurality of lens units.

In Example 4, the zoom lens includes, in order from the object side to the image side, a first lens unit B1, a second lens unit B2, and a third lens unit B3 having positive refractive power. The zoom lens according to Example 4 consists of these lens units B1 to B3 and an optical block GB located closest to the image plane. The aperture stop SP is disposed closest to the object of the second lens unit B2. The flare cut diaphragm FP is disposed closest to the image plane of the second lens unit B2. During zooming from the wide-angle end to the telephoto end, the third lens unit B3 moves toward the object side so that the distance between the second lens unit B2 and the third lens unit B3 increases. Example 4 adopts such a lens unit configuration, and can realize a zoom lens with a small number of lenses and reduce the thickness of the camera in the retracted state.

In Examples 1 and 2, the third lens unit B3 moves along the optical axis during focusing from infinity to close. In Example 3, during focusing from infinity to close. The focus lens unit move to the image side.

In Example 4, the third lens unit B3 moves along the optical axis during focusing from infinity to close. In Example 4, during focusing on a close object, the focus lens unit moves toward the object side.

In any of the examples, the focus lens unit includes a single lens. Constructing the focus lens unit with a single lens can reduce the weight of the focus lens unit and achieve high-speed focusing. On the other hand, the focus lens unit may include a plurality of lenses. In this case, performance fluctuations during focusing can be suppressed.

In the zoom lens according to each example, the second lens unit B2 moves in the direction orthogonal to the optical axis during image stabilization. This configuration can correct the shake of a captured image in a case where the entire zoom lens vibrates. Each example performs image stabilization without newly adding an optical member such as a variable apex angle prism or an image stabilizing lens unit. This prevents the entire zoom lens from becoming larger.

Each example performs image stabilization by moving the second lens unit B2 in the direction orthogonal to the optical axis for image stabilization, but can correct the shake in an captured image simply by moving the image stabilizing lens unit in a direction having a component in the direction orthogonal to the optical axis. For example, in a case where the complicated lens barrel structure is permitted, image stabilization may be performed by rotating the image stabilizing lens unit so as to have the rotation center on the optical axis. The image stabilizing lens unit may include, in addition to the second lens unit B2, one or more lens units such as the first lens unit B1 and the third lens unit B3, and the entire zoom lens.

A description will now be given of numerical examples 1 to 4 corresponding to examples 1 to 4.

In surface data of each numerical example, r represents a radius of curvature of each optical surface, and d (mm) represents an on-axis distance (distance on the optical axis) between an m-th surface and an (m+1)-th surface, where m is a surface number counted from the light incident side. nd represents a refractive index for the d-line of each optical element, and νd represents an Abbe number of the optical element. The Abbe number νd of a certain material is expressed as follows:

νd=(Nd−1)/(NF−NC)

where Nd, NF, and NC are refractive indices based on the d-line (587.6 nm), the F-line (486.1 nm), and the C-line (656.3 nm) in the Fraunhofer line, respectively. An effective diameter means a maximum diameter of an area (effective area) of the lens surface through which an effective light beam that contributes to imaging passes.

In each numerical example, values of d, focal length (mm), F-number, and half angle of view (°) are set in a case where the optical system according to each example is in an in-focus state on an infinity object. “Back focus BF” is a distance on the optical axis from the final lens surface (lens surface closest to the image plane) to the paraxial image plane expressed in air conversion length. An “overall lens length” is a length obtained by adding the back focus to a distance on the optical axis from the frontmost lens surface (lens surface closest to the object) to the final lens surface of the optical system. The term “lens unit” includes one or more lenses.

In a case where the optical surface is an aspherical surface, an asterisk * is attached to the right side of the surface number. The aspherical shape is expressed as follows:

X=(h²/R)/[1+{1−(1+k)(h/R)²}^{1/2}]+A4×h⁴+A6×h⁶+A8×h⁸+A10×h¹⁰+A12×h¹²+A14×h¹⁴

where X is a displacement amount from a surface vertex in the optical axis direction, h is a height from the optical axis in a direction orthogonal to the optical axis, a light traveling direction is set positive, R is a paraxial radius of curvature, k is a conic constant, and A4, A6, A8, A10, A12, and A14 are aspherical coefficients. “e±XX” in each aspheric coefficient means “×10^{±XX}.”

The last two surfaces in the numerical example are the surfaces of the optical block GB such as filters and faceplates.

### Numerical Example 1

SURFACE DATA

| Surface | | | | | Effective |
|---|---|---|---|---|---|
| No | r | d | nd | νd | Diameter |
| 1 | 34.559 | 1.15 | 1.80400 | 46.6 | 26.20 |
| 2 | 13.402 | 3.18 | | | 20.70 |
| 3* | 25.765 | 1.00 | 1.76802 | 49.2 | 20.30 |
| 4* | 9.618 | 5.23 | | | 17.30 |
| 5 | −68.044 | 0.75 | 1.49700 | 81.5 | 17.20 |
| 6 | 80.978 | 0.10 | | | 17.00 |
| 7 | 22.465 | 1.84 | 1.96300 | 24.1 | 17.00 |
| 8 | 66.459 | (Variable) | | | 16.80 |
| 9 (Aperture | ∞ | 0.70 | | | 10.60 |
| Stop) | | | | | |
| 10* | 11.142 | 3.17 | 1.85135 | 40.1 | 11.50 |
| 11* | −133.589 | 2.36 | | | 11.00 |
| 12 | 182.741 | 0.45 | 2.00100 | 29.1 | 9.40 |
| 13 | 7.481 | 4.63 | 1.49700 | 81.5 | 8.80 |
| 14 | −13.433 | 0.00 | | | 8.90 |
| 15 | ∞ | (Variable) | | | 8.64 |
| 16 | −54.314 | 0.45 | 1.85135 | 40.1 | 10.80 |
| 17* | 111.710 | (Variable) | | | 11.10 |
| 18 | −141.843 | 2.10 | 2.05090 | 26.9 | 22.00 |
| 19 | −34.270 | (Variable) | | | 22.20 |
| 20 | ∞ | 1.00 | 1.51633 | 64.1 | 25.00 |
| 21 | ∞ | (Variable) | | | 25.00 |
| Image Plane | ∞ | | | | |

ASPHERIC DATA
3rd Surface
K = 0.00000e+00 A4 = 7.14552e−05 A6 = −1.40789e−06
A8 = 9.23882e−09 A10 = −2.44195e−11
4th Surface
K = −2.47491e+00 A4 = 3.59139e−04 A6 = −2.84689e−06
A8 = 1.16097e−08 A10 = −4.29347e−11 A12 = 1.09664e−12
A14 = −8.01345e−15
10th Surface
K = 0.00000e+00 A4 = −2.40895e−05 A6 = −2.28960e−08
A8 = 9.44796e−11 A10 = 8.34495e−12
11th Surface
K = 0.00000e+00 A4 = 8.22257e−05 A6 = −7.74388e−08
17th Surface
K = 0.00000e+00 A4 = 6.10849e−05

VARIOUS DATA
ZOOM RATIO 2.94

| | WIDE | MIDDLE | TELEPHOTO |
|---|---|---|---|
| Focal Length | 8.55 | 13.40 | 25.12 |
| Fno | 2.88 | 3.55 | 4.63 |
| Half Angle of View (°) | 46.98 | 38.21 | 23.97 |
| Image Height | 9.16 | 10.55 | 11.17 |
| Overall Lens Length | 67.80 | 62.71 | 68.14 |
| BF | 1.00 | 1.00 | 1.00 |
| d8 | 21.73 | 10.76 | 3.29 |
| d15 | 4.16 | 6.44 | 11.05 |
| d17 | 4.69 | 6.92 | 18.58 |
| d19 | 8.11 | 9.48 | 6.10 |
| d21 | 1.00 | 1.00 | 1.00 |

### Numerical Example 2

SURFACE DATA

| Surface | | | | | Effective |
|---|---|---|---|---|---|
| No | r | d | nd | νd | Diameter |
| 1 | 30.290 | 1.15 | 1.87070 | 40.7 | 26.20 |
| 2 | 13.210 | 2.93 | | | 20.80 |
| 3* | 15.149 | 1.00 | 1.76802 | 49.2 | 20.30 |
| 4* | 7.837 | 5.59 | | | 17.40 |
| 5 | −59.709 | 0.75 | 1.49700 | 81.5 | 17.30 |
| 6 | 55.391 | 0.10 | | | 17.10 |
| 7 | 20.408 | 2.10 | 1.96300 | 24.1 | 17.10 |
| 8 | 60.060 | (Variable) | | | 16.70 |
| 9 (Aperture | ∞ | 0.70 | | | 9.85 |
| Stop) | | | | | |
| 10* | 9.093 | 3.84 | 1.69350 | 53.2 | 10.80 |
| 11* | −40.930 | 1.95 | | | 10.00 |
| 12 | −15.024 | 0.45 | 1.91082 | 35.2 | 8.70 |
| 13 | 8.585 | 4.12 | 1.59201 | 67.0 | 8.50 |
| 14* | −9.635 | 0.00 | | | 8.70 |
| 15 | ∞ | (Variable) | | | 8.41 |
| 16 | 195.726 | 0.45 | 1.64769 | 33.8 | 10.60 |
| 17 | 23.997 | (Variable) | | | 10.90 |
| 18 | 54.409 | 2.05 | 1.95375 | 32.3 | 22.10 |
| 19 | −258.023 | (Variable) | | | 22.10 |
| 20 | ∞ | 1.00 | 1.51633 | 64.1 | 22.10 |
| 21 | ∞ | (Variable) | | | 25.00 |
| Image Plane | ∞ | | | | 25.00 |

ASPHERIC DATA
3rd Surface
K = 0.00000e+00 A4 = −2.04615e−04 A6 = 1.41784e−06
A8 = −8.47706e−09 A10 = 1.49674e−11
4th Surface
K = −2.81244e+00 A4 = 3.53120e−04 A6 = −5.32296e−06
A8 = 9.13935e−08 A10 = −1.00302e−09 A12 = 5.84154e−12
A14 = −1.48652e−14
10th Surface
K = 0.00000e+00 A4 = 2.16655e−05 A6−2.03357e−06
A8 = −4.05626e−08 A10 = 1.61069e−09
11th Surface
K = 0.00000e+00 A4 = 2.02553e−04 A6 = 2.77261e−07
14th Surface
K = 0.00000e+00 A4 = 1.43920e−04 A6 = 4.50577e−06
A8 = −1.10280e−07 A10 = 6.95123e−09

VARIOUS DATA
ZOOM RATIO 2.94

| | WIDE | MIDDLE | TELEPHOTO |
|---|---|---|---|
| Focal Length | 8.55 | 12.40 | 25.12 |
| Fno | 2.88 | 3.55 | 4.63 |
| Half Angle of View (°) | 46.98 | 39.63 | 23.97 |
| Image Height | 9.16 | 10.27 | 11.17 |
| Overall Lens Length | 66.71 | 61.05 | 66.73 |
| BF | 1.00 | 1.00 | 1.00 |
| d8 | 20.60 | 10.69 | 1.65 |
| d15 | 2.96 | 4.74 | 9.26 |
| d17 | 4.89 | 5.84 | 19.67 |
| d19 | 9.10 | 10.62 | 6.99 |
| d21 | 1.00 | 1.00 | 1.00 |

### Numerical Example 3

| Surface | | | | | Effective |
|---|---|---|---|---|---|
| No | r | d | nd | νd | Diameter |
| 1 | 32.987 | 1.15 | 1.91082 | 35.2 | 27.20 |
| 2 | 14.081 | 3.00 | | | 21.80 |
| 3* | 16.227 | 1.00 | 1.85135 | 40.1 | 21.50 |
| 4* | 8.541 | 6.24 | | | 18.80 |
| 5 | −33.921 | 0.75 | 1.49700 | 81.5 | 18.70 |
| 6 | −2185.280 | 0.10 | | | 18.70 |
| 7 | 29.769 | 2.06 | 1.96300 | 24.1 | 18.70 |
| 8 | 249.451 | (Variable) | | | 18.50 |
| 9 (Aperture | ∞ | −0.10 | | | 11.18 |
| Stop) | | | | | |
| 10* | 11.296 | 2.41 | 1.85135 | 40.1 | 11.80 |
| 11* | 58.990 | 3.40 | | | 11.40 |
| 12 | 117.224 | 0.45 | 1.95375 | 32.3 | 10.00 |
| 13 | 7.144 | 4.87 | 1.59201 | 67.0 | 9.50 |
| 14* | −18.879 | 0.00 | | | 9.70 |
| 15 | ∞ | (Variable) | | | 9.49 |
| 16 | −72.589 | 1.08 | 1.85135 | 40.1 | 10.90 |
| 17* | −27.021 | (Variable) | | | 11.10 |
| 18 | −24.154 | 0.45 | 1.95375 | 32.3 | 11.30 |
| 19 | −236.922 | (Variable) | | | 11.70 |
| 20 | −42.921 | 1.73 | 1.60311 | 60.6 | 16.90 |
| 21 | −20.402 | (Variable) | | | 17.20 |
| 22 | ∞ | 1.00 | 1.51633 | 64.1 | 25.00 |
| 23 | ∞ | (Variable) | | | 25.00 |
| Image Plane | ∞ | | | | |

ASPHERIC DATA
3rd Surface
K = 0.00000e+00 A4 = −1.92027e−04 A6 = 1.32497e−06
A8 = −7.86416e−09 A10 = 1.64340e−11
4th Surface
K = −3.17427e+00 A4 = 2.84911e−04 A6 = −4.50890e−06
A8 = 6.72856e−08 A10 = −6.39844e−10 A12 = 3.01447e−12
A14 = −5.06324e−15
10th Surface
K = 0.00000e+00 A4 = 1.11849e−06 A6 = −3.07440e−08
A8 = 6.90691e−11 A10 = −7.56109e−12
11th Surface
K = 0.00000e+00 A4 = 5.99525e−05 A6 = −1.30498e−07
14th Surface
K = 0.00000e+00 A4 = 7.12243e−06 A6 = −3.26345e−07
A8 = 1.95017e−08 A10 = −7.36282e−10
17th Surface
K = 0.00000e+00 A4 = 3.18636e−05 A6 = 1.22609e−07
A8 = −8.56174e−09 A10 = 1.29997e−10

VARIOUS DATA
ZOOM RATIO 4.07

| | WIDE | MIDDLE | TELEPHOTO |
|---|---|---|---|
| Focal Length | 8.55 | 17.40 | 34.82 |
| Fno | 2.88 | 3.98 | 5.77 |
| Half Angle of View (°) | 46.98 | 31.73 | 17.78 |
| Image Height | 9.16 | 10.76 | 11.17 |
| Overall Lens Length | 76.55 | 70.44 | 84.57 |
| BF | 1.00 | 1.00 | 1.00 |
| d8 | 27.72 | 9.82 | 0.60 |
| d15 | 2.98 | 8.61 | 17.46 |
| d17 | 2.00 | 1.31 | 1.00 |
| d19 | 3.24 | 7.18 | 13.90 |
| d21 | 10.02 | 12.93 | 21.01 |
| d23 | 1.00 | 1.00 | 1.00 |

### Numerical Example 4

SURFACE DATA

| Surface | | | | | Effective |
|---|---|---|---|---|---|
| No | r | d | nd | νd | Diameter |
| 1 | 38.160 | 1.15 | 1.80400 | 46.5 | 26.30 |
| 2 | 13.766 | 2.89 | | | 20.80 |
| 3* | 16.581 | 1.00 | 1.69350 | 53.2 | 20.60 |
| 4* | 6.836 | 5.69 | | | 17.20 |
| 5 | −108.653 | 0.75 | 1.49700 | 81.5 | 17.20 |
| 6 | 151.131 | 0.10 | | | 17.10 |
| 7 | 18.854 | 1.90 | 1.96300 | 24.1 | 17.20 |
| 8 | 38.380 | (Variable) | | | 16.80 |
| 9 (Aperture | ∞ | 0.70 | | | 9.54 |
| Stop) | | | | | |
| 10* | 10.083 | 2.33 | 1.69350 | 53.2 | 10.00 |
| 11* | 1625.266 | 3.45 | | | 9.60 |
| 12 | −981.431 | 0.45 | 1.91082 | 35.2 | 7.90 |
| 13 | 7.683 | 3.37 | 1.49710 | 81.6 | 7.60 |
| 14* | −13.655 | 0.00 | | | 7.50 |
| 15 | ∞ | (Variable) | | | 7.54 |
| 16* | 42.101 | 1.92 | 1.49710 | 81.6 | 20.40 |
| 17 | 1065.880 | (Variable) | | | 20.50 |
| 18 | ∞ | 1.00 | 1.51633 | 64.1 | 25.00 |
| 19 | ∞ | (Variable) | | | 25.00 |
| Image Plane | ∞ | | | | |

ASPHERIC DATA
3rd Surface
K = 0.00000e+00 A4 = −2.65442e−04 A6 = 2.63330e−06
A8 = −1.75543e−08 A10 = 4.33556e−11
4th Surface
K = −1.78639e+00 A4 = 1.05524e−04 A6 = 1.74439e−07
A8 = −6.11432e−09 A10 = 4.28950e−10 A12 = −8.14464e−12
A14 = 4.38089e−14
10th Surface
K = 0.00000e+00 A4 = −1.63439e−05 A6 = 7.55048e−07
A8 = −2.61638e−08 A10 = 6.67195e−10
11th Surface
K = 0.00000e+00 A4 = 9.55366e−05 A6 = 3.83977e−07
14th Surface
K = 0.00000e+00 A4 = 3.85530e−05 A6 = 3.07213e−06
A8 = −1.72685e−07 A10 = 6.20174e−09
16th Surface
K = 0.00000e+00 A4 = −1.77187e−05 A6 = 4.29809e−08

VARIOUS DATA
ZOOM RATIO 2.94

| | WIDE | MIDDLE | TELEPHOTO |
|---|---|---|---|
| Focal Length | 8.55 | 12.54 | 25.12 |
| Fno | 2.88 | 3.98 | 5.77 |
| Half Angle of View (°) | 46.98 | 39.45 | 23.97 |
| Image Height | 9.16 | 10.32 | 11.17 |
| Overall Lens Length | 67.43 | 64.65 | 73.48 |
| BF | 1.00 | 1.00 | 1.00 |
| d8 | 20.49 | 11.88 | 1.58 |
| d15 | 12.96 | 19.78 | 33.09 |
| d17 | 6.28 | 5.29 | 11.12 |
| d19 | 1.00 | 1.00 | 1.00 |

Table 1 below summarizes various values in each numerical example.

TABLE 1

| | | Exam- | Exam- | Exam- | Exam- |
|---|---|---|---|---|---|
| Inequality | | ple 1 | ple 2 | ple 3 | ple 4 |
| (1) | G1R2/D1 | 1.011 | 0.970 | 0.985 | 1.021 |
| (2) | fa/fw | −4.703 | −4.878 | −5.057 | −4.245 |
| (3) | N1 | 1.804 | 1.871 | 1.911 | 1.804 |
| (4) | (G1R2 + G2R1)/ | 3.121 | 4.058 | 3.712 | 3.201 |
| | (G1R2 − G2R1) | | | | |
| (5) | D1/fw | 1.550 | 1.592 | 1.673 | 1.577 |
| (6) | dg12/fw | 0.372 | 0.342 | 0.351 | 0.339 |
| (7) | fgho/Lw | 0.242 | 0.622 | 0.783 | 1.248 |
| (8) | f1/fw | −1.758 | −1.829 | −1.889 | −1.669 |
| (9) | f1/f2 | −0.916 | −0.970 | −0.835 | −0.766 |

### Image Pickup Apparatus

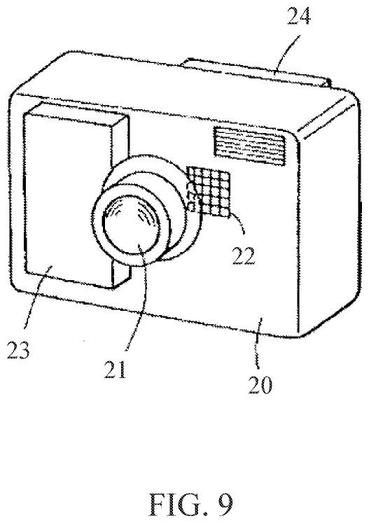

Referring now to FIG. 9, a description will be given of an embodiment of a digital still camera (image pickup apparatus) using a zoom lens according to each example as an imaging optical system.

In FIG. 9, reference numeral 20 denotes a camera body, and reference numeral 21 denotes an imaging optical system including one of the zoom lenses according to Examples 1 to 4. Reference numeral 22 denotes a solid-state image sensor (photoelectric conversion element) such as a CCD sensor or CMOS sensor, which is built in the camera body 20 and configured to receive and photoelectrically convert an optical image formed by the imaging optical system 21. The camera body 20 may be a so-called single-lens reflex camera with a quick turn mirror, or a so-called mirrorless camera without a quick turn mirror. Reference numeral 23 denotes a memory that records information corresponding to an object image photoelectrically converted by the solid-state image sensor 22. Reference numeral 24 denotes a viewfinder that includes a liquid crystal display panel or the like, and is used to observe the object image formed on the solid-state image sensor 22.

Thus, applying the zoom lens according to each example to an image pickup apparatus such as a digital still camera can realize an image pickup apparatus having a compact, high-performance, and high-magnification zoom lens.

### Imaging System

An imaging system (surveillance camera system) may include the zoom lens according to each example and a control unit configured to control the zoom lens. In this case, the control unit can control the zoom lens so that each lens unit moves as described above during zooming, focusing, and image stabilization. At this time, the control unit may not be integrated with the zoom lens, and may be separate from the zoom lens. For example, a configuration may be employed in which a control unit (control apparatus) disposed remotely from a driving unit that drives each lens in a zoom lens may include a transmitter that transmits a control signal (command) for controlling the zoom lens. Such a control unit can remotely control the zoom lens.

Providing an operation unit such as a controller and a button for remotely operating the zoom lens to the control unit may control the zoom lens according to the input of the user to the operation unit. For example, the operation unit may include an enlargement button and a reduction button. A signal may be sent from the control unit to the driving unit of the zoom lens so that in a case where the user presses the enlarge button, the magnification of the zoom lens increases, and in a case where the user presses the reduce button, the magnification of the zoom lens decreases.

The imaging system may also include a display unit such as a liquid crystal panel that displays information (moving state) about zooming of the zoom lens. The information about the zoom of the zoom lens includes, for example, zoom magnification (zoom state) and a moving amount (moving state) of each lens unit. In this case, the user can remotely operate the zoom lens via the operation unit while viewing information about the zoom of the zoom lens displayed on the display unit. The display unit and the operation unit may be integrated by adopting a touch panel or the like.

Each example can provide a zoom lens that can achieve both a wide angle and high magnification while avoiding ghosts.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-122144, filed on Jul. 29, 2022, which is hereby incorporated by reference herein in its entirety.

What is claimed is:

1. A zoom lens comprising, in order from an object side to an image side, a first lens unit having negative refractive power, a second lens unit having positive refractive power,
wherein a distance between adjacent lens units changes during zooming from a wide-angle end to a telephoto end,
wherein during zooming from the wide-angle end to the telephoto end, the first lens unit moves to the image side and then to the object side,
wherein the first lens unit includes four lenses or more, the four lenses or more including, in order from the object side to the image side, a first negative meniscus lens with a convex surface facing the object side and a second negative meniscus lens with a convex surface facing the object side, and
wherein the following inequalities are satisfied:
0.9<G1R2/D1<2.0
−9.0<fa/fw<−2.0
1.8<N1<2.1
where G1R2 is a radius of curvature of a lens surface on the image side of the first negative meniscus lens, D1 is a distance on an optical axis from a lens surface closest to an object to a lens surface closest to an image plane of the first lens unit, fa is a focal length of an air lens between the first negative meniscus lens and the second negative meniscus lens, fw is a focal length of the zoom lens at the wide-angle end, and N1 is a refractive index of the first negative meniscus lens.

2. The zoom lens according to claim 1, wherein during zooming from the wide-angle end to the telephoto end, the first lens unit and the second lens unit move so as to narrow a distance between the first lens unit and the second lens unit.

3. The zoom lens according to claim 1, wherein the first lens unit includes a negative lens and a positive lens disposed on the image side of the first negative meniscus lens and the second negative meniscus lens.

4. The zoom lens according to claim 1, where the following inequality is satisfied:
2.0<(G1R2+G2R1)/(G1R2−G2R1)<6.0
where G2R1 is a radius of curvature of a lens surface on the object side of the second negative meniscus lens.

5. The zoom lens according to claim 1, where the following inequality is satisfied:
1.2<D1/fw<2.0.

6. The zoom lens according to claim 1, wherein the following inequality is satisfied:
0.3<dg12/fw<0.6
where dg12 is a distance on the optical axis from a lens surface on the image side of the first negative meniscus lens to a lens surface on the object side of the second negative meniscus lens.

7. The zoom lens according to claim 1, wherein the following inequality is satisfied:
0.1<fgho/Lw<1.5
where fgho is a focal length of the first lens unit in a case where a light ray incident on the first lens unit is reflected by a lens surface on the object side of the second negative meniscus lens, is reflected on a lens surface on the image side of the first lens unit, and exits the first lens unit, and Lw is an overall optical length of the zoom lens at the wide-angle end.

8. The zoom lens according to claim 1, comprising, in order from the object side to the image side, the first lens unit, the second lens unit, a third lens unit having negative refractive power, and a fourth lens unit having positive refractive power.

9. The zoom lens according to claim 8, wherein during zooming from the wide-angle end to the telephoto end, the third lens unit moves toward the object side and the fourth lens unit moves toward the image side so that a distance between the second lens unit and the third lens unit increases and a distance between the third lens unit and the fourth lens unit increases.

10. The zoom lens according to claim 8, wherein the third lens unit moves toward the image side during focusing from infinity to close.

11. The zoom lens according to claim 1, comprising, in order from the object side to the image side, the first lens unit, the second lens unit, a third lens unit having positive refractive power, and a fourth lens unit having negative refractive power, and a fifth lens unit having positive refractive power.

12. The zoom lens according to claim 11, wherein during zooming from the wide-angle end to the telephoto end, each of the third lens unit, the fourth lens unit, and the fifth lens unit moves toward the object side so that a distance between the second lens unit and the third lens unit increases, a distance between the third lens unit and the fourth lens unit narrows, and a distance between the fourth lens unit and the fifth lens unit increases.

13. The zoom lens according to claim 11, wherein the fourth lens unit moves toward the image side during focusing from infinity to close.

14. The zoom lens according to claim 1, comprising, in order from the object side to the image side, the first lens unit, the second lens unit, and a third lens unit having positive refractive power.

15. The zoom lens according to claim 14, wherein during zooming from the wide-angle end to the telephoto end, the third lens unit moves toward the image side so that a distance between the second lens unit and the third lens unit increases.

16. The zoom lens according to claim 14, wherein the third lens unit moves toward the object side during focusing from infinity to close.

17. The zoom lens according to claim 1, wherein the first lens unit includes an aspherical lens.

18. The zoom lens according to claim 17, wherein at least one lens surface of the second negative meniscus lens is aspheric.

19. The zoom lens according to claim 1, wherein the following inequality is satisfied:
−2.5<f1/fw<−1.5
where f1 is a focal length of the first lens unit.

20. The zoom lens according to claim 1, wherein the following inequality is satisfied:
−1.5<f1/f2<−0.5
where f1 is a focal length of the first lens unit, and f2 is a focal length of the second lens unit.

21. An image pickup apparatus comprising:
a zoom lens; and
an image sensor configured to receive an image formed by the zoom lens,
wherein the zoom lens includes, in order from an object side to an image side, a first lens unit having negative refractive power, a second lens unit having positive refractive power,
wherein a distance between adjacent lens units changes during zooming from a wide-angle end to a telephoto end,
wherein during zooming from the wide-angle end to the telephoto end, the first lens unit moves to the image side and then to the object side,
wherein the first lens unit includes four lenses or more, the four lenses or more including, in order from the object side to the image side, a first negative meniscus lens with a convex surface facing the object side and a second negative meniscus lens with a convex surface facing the object side, and
wherein the following inequalities are satisfied:
0.9<G1R2/D1<2.0
−9.0<fa/fw<−2.0
1.8<N1<2.1
where G1R2 is a radius of curvature of a lens surface on the image side of the first negative meniscus lens, D1 is a distance on an optical axis from a lens surface closest to an object to a lens surface closest to an image plane of the first lens unit, fa is a focal length of an air lens between the first negative meniscus lens and the second negative meniscus lens, fw is a focal length of the zoom lens at the wide-angle end, and N1 is a refractive index of the first negative meniscus lens.
